(19) United States
(12) Patent Application Publication
(10) Pub. No.: US 2005/0077737 A1
(43) Pub. Date: Apr. 14, 2005

(54) Connector

(76) Inventors: Ryuichi Komiyama, Tokyo (JP); Yoshinori Hitomi, Toyota-shi (JP); Katsutoshi Fukunaga, Chiryu-shi (JP); Makoto Suzumura, Chita-shi (JP); Yukinobu Kunimatsu, Toyoake-shi (JP)

Correspondence Address: BARLEY SNYDER, LLC, 1000 WESTLAKES DRIVE, SUITE 275, BERWYN, PA, 19312, US

(21) Appl. No.: 10/938,684

(22) Filed: Sep. 10, 2004

(30) Foreign Application Priority Data
Sep. 10, 2003 (JP) 2003-318733

(51) Int. Cl. E05B 3/00

(52) U.S. Cl. 292/336.3

(57) ABSTRACT

The present invention relates to a connector attached to a fulcrum end of a pivotal door handle and into which wiring extending from a sensor is introduced, the sensor being built into the door handle to detect a predetermined signal from surroundings, the connector having a contact connected to the wiring. The present invention reliably prevents water from infiltrating into the connector and eliminates the necessity to also replace the door handle when the connector is replaced. The connector includes paired latch arms provided on respective sides of the door handle and which can be installed in and removed from the door handle; and a seal member provided at a port through which wiring is introduced.

### FIELD OF THE INVENTION

The present invention relates to a connector which is attached to a fulcrum end of a pivotal door handle and wired to a sensor built into the door handle to detect a predetermined signal from surroundings.

### BACKGROUND

The use of keyless entry systems has increased for applications such as automobiles and the like. The keyless entry systems unlock a locked door using a predetermined signal which is transmitted and detected to unlock the door instead of inserting a key into a keyhole for unlocking. Some of the automobiles employing a keyless system have a sensor built into a door handle to detect the predetermined signal.

Europe Patent Application Laid-Open No. 1031683 discloses a set of mating connectors that interconnect a cable from a sensor detecting a predetermined signal and a cable from a control section provided inside a door. The sensor detecting the predetermined signal is built into the door handle. The set of connectors are located inside a door panel. The door handle described in Europe Patent Application Laid-Open No. 1031683 is pivotally moved using one end as a fulcrum. The end acting as a fulcrum is inserted into the door panel. The door panel is provided with a seal member that prevents water from infiltrating into the set of connectors. The fulcrum end of the door handle and the cable extending from the sensor both penetrate the seal member.

However, pivoting motion of the door handle causes both the ends acting as the fulcrum and the cable extending from the sensor to move forward and backward with respect to the seal member. As the door is used for a long time, the waterproof property of the seal member is lost. As a result, water may infiltrate into the connectors, located inside the door panel, through the door handle or the cable.

Mating the connectors with one another is completed during the process of attaching the door handle to the door panel. The connector extending from the sensor is secured to the fulcrum end of the door handle and is integrated with the door handle. Thus, even if the door handle is not defective, the door handle must be replaced together with the connector if the connector is defective.

Japanese Patent Laid-Open No. 2000-160897 and Japanese Patent Laid-Open No. 2003-200792 disclose a door handle having built-in wires but do not refer to a waterproof structure for the wires.

Japanese Patent Laid-Open No. 2000-299161, Japanese Utility Model Registered No. 2554457, and Japanese Patent Laid-Open No. 2000-195609 disclose a waterproof structure for connectors but do not refer to the provision of the connectors in a door handle.

### SUMMARY

The present invention has been made in view of the above circumstances and provides a connector which can reliably prevent water from infiltrating into the connector and which can eliminate the necessity to also replace a door handle when the connector is replaced.

In an exemplary embodiment, the present invention provides a connector attached to a fulcrum end of a pivotal door handle and into which wiring extending from a sensor is introduced, the sensor being built into the door handle to detect a predetermined signal from surroundings, the connector having a contact connected to the wiring. The connector includes:
a pair of latch arms provided on respective sides of the door handle and which can be installed in and removed from the door handle; and
a seal member provided at a port through which the wiring is introduced.

According to the connector of the present invention, the pair of latch arms allows the connector to be installed in and removed from the door handle. This eliminates the necessity to also replace a door handle when the connector is replaced. Further, the seal member reliably prevents water from infiltrating into the connector.

### BRIEF DESCRIPTION OF THE DRAWINGS

FIG. 1 is a perspective view of a door handle of an automobile with a male connector attached to it according to an exemplary embodiment of the present invention;

FIG. 2 is an exploded perspective view of a connector according to an exemplary embodiment of the present invention and a mating connector;

FIG. 3 is a perspective view showing a fulcrum end of the door handle shown in FIG. 1;

FIG. 4 is a perspective view of a male connector according to a second exemplary embodiment as viewed from a wiring introduction port;

FIG. 5 is a sectional view of the male connector of the second embodiment to which an FPC is connected, the view being taken along a direction in which the male connector is fitted into the mating connector;

FIG. 6 is an exploded perspective view of a female connector according to a third exemplary embodiment as viewed from a wiring introduction port; and

FIG. 7 is an exploded perspective view of a female connector according to an alternative form of the third embodiment as viewed from the wiring introduction port.

### DETAILED DESCRIPTION OF THE EMBODIMENT(S)

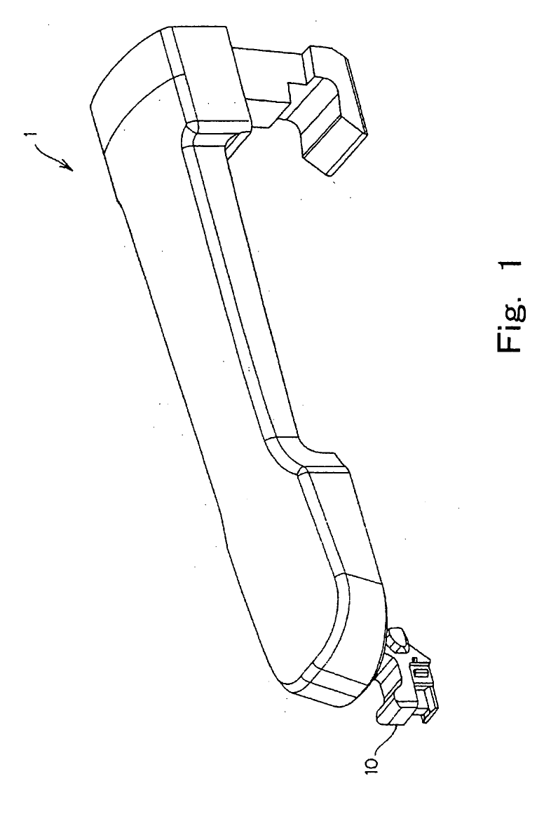

FIG. 1 shows a door handle 1 of an automobile to which a male connector (not shown in FIG. 1) is attached.

Opposite ends of the door handle 1, shown in FIG. 1, are inserted into the inside of a door panel of an automobile (not shown). The door handle 1 is pivotally attached to the door panel using a left end 10 in the figure as a rotative movement fulcrum. The door handle 1, shown in FIG. 1, has a built-in sensor (not shown). The sensor detects a predetermined signal. An automobile to which the door handle 1 is attached is provided with a control section that unlocks a door when the sensor detects the predetermined signal. The predetermined signal is continuously transmitted by a key, such as an ignition key. Thus, if the door handle 1, shown in FIG. 1, is attached to the automobile, when a person carrying the key approaches the automobile, the door is automatically unlocked. The predetermined signal may be transmitted by an exclusive portable transmitter instead of the key. Optionally, the predetermined signal may be transmitted only when a user performs an operation such as depression of a button.

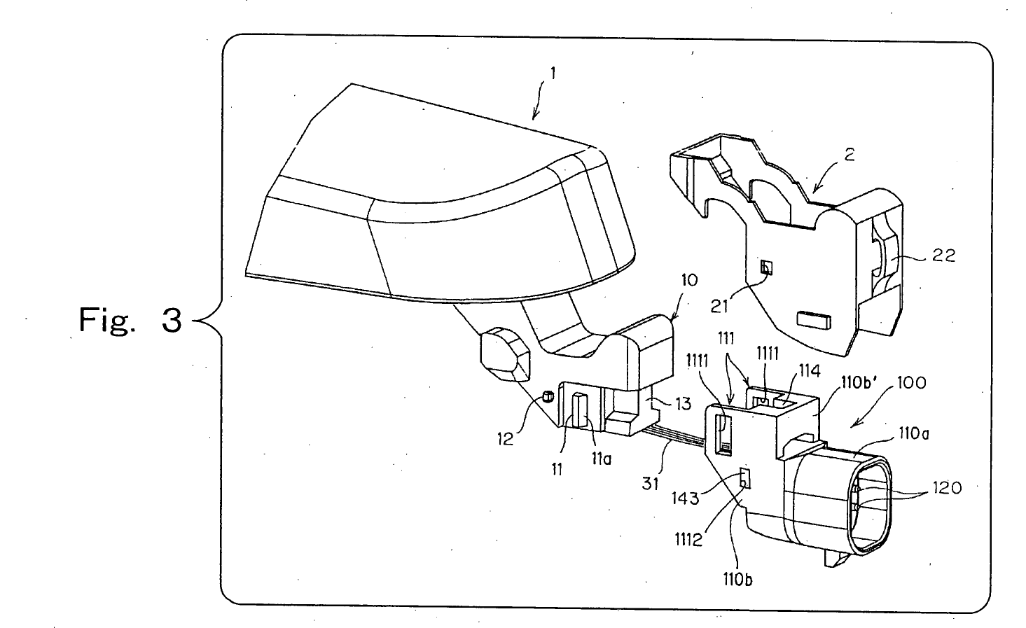

The connector (100 in FIG. 3) is attached to the fulcrum end 10 of the door handle 1, shown in FIG. 1. Although not shown, wiring extends from the sensor built into the door handle 1. A leading end of the wiring is introduced into the connector of the present embodiment.

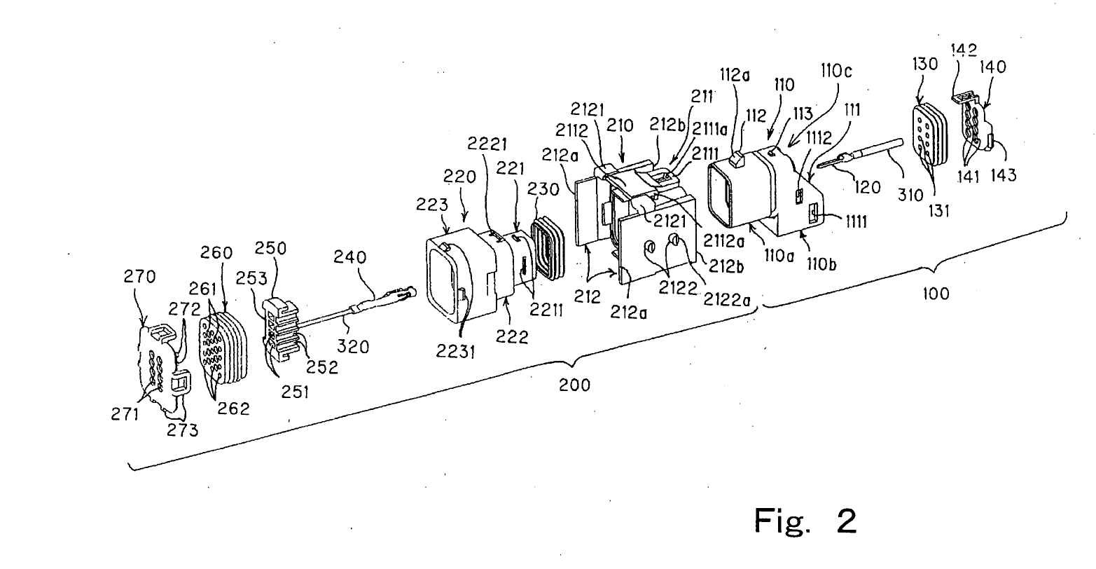

FIG. 2 is an exploded perspective view of a male connector and a female connector to which the male connector is connected according to an embodiment of the present embodiment.

The right side of FIG. 2 shows a male connector 100 according to an exemplary embodiment of the present invention. The male connector 100 according to the present embodiment has a housing 110, a male contact 120, a batch rubber stopper 130, and a cover member 140.

One conductor 310 is connected to one male contact 120, shown in FIG. 2. FIG. 2 shows only one male contact 120 but the wiring introduced into the male connector 100, shown in FIG. 2, is composed of eight conductors with a circular cross section. Actually, eight male contacts 120 are provided.

A housing 110 shown in FIG. 2 has a main body section 110c, hood section 110a extending frontward from the main body section 110c and a wing section 110b extending rearward and downward from the main body section 110c. The eight male contacts 120 are accommodated in the hood section 110a and main body section 110c. A large locking projection 112 is provided on an outer peripheral surface of the hood section 110a. The wing section 110b is provided with paired latch arms 111. A small locking projection 113 is provided on a top surface of the main body section 110c. The paired latch arms 111 are provided on respective sides of the housing 110. The paired latch arms 111 project in a direction opposite to that in which a female connector 200 is mated with the male connector 100. Each of the paired latch arms 111 has a large locking slot 1111 and a small locking slot 1112. The male connector 100, shown in FIG. 2, is removably attached to the door handle 1 by the paired latch arms 111. A detailed description of a method of attaching the latch arms 111 is omitted here and will be given later.

The batch rubber stopper 130, shown in FIG. 2, is a plate-like rubber member having eight through-holes 131. The eight conductors are inserted through the respective through-holes 131. The wiring introduced into the male connector 100 extends from the right end of FIG. 2 having eight conductors 310 with their leading end connected to respective male contacts 120. The batch rubber stopper 130 in the male connector 100 is placed at a rear end of the male connector 100. That is, the batch rubber stopper 130 is provided at a port in the male connector 100 into which the wiring is introduced. Accordingly, the batch rubber stopper 130 prevents water running along the wiring from infiltrating into the male connector 100. This reliably makes the male connector 100 waterproof. Further, even if the wiring introduced into the connector is composed of multiple conductors as described above, the use of the batch rubber stopper 130 enables the waterproof property to be enhanced using only a small number of parts.

The cover member 140, shown in FIG. 2, is also formed with eight through-holes 141 corresponding to the eight through-holes 131, formed in the batch rubber stopper 130. The eight conductors 310 are inserted through the respective through-holes 141. The cover member 140 is also provided with a locking lever 142 and locking pawls 143. The small locking projection 113, provided on the main body section 110c of the housing 110, slips into the locking lever 142. The locking pawls 143 are provided on respective sides of the cover member 140. The locking pawls 143 slip into the respective smaller locking holes 1112, formed in the paired latch arms 111 of the housing 110. Since the locking projection 113 slips into the locking lever 142 and the locking pawls 143 slip into the respective locking holes 1112, the cover member 140 is fixed to the housing 110 so as to press the batch rubber stopper 130.

Now, a process of assembling the male connector 100, shown in FIG. 2 will be described.

First, the leading ends of the eight conductors 310 are passed through the respective through-holes 141 in the cover member 140 and then through the respective through-holes 131 in the batch rubber stopper 130. Next, a connecting operation is performed. During the connecting operation, the leading ends of the eight conductors 310 are crimped to the respective male contacts 120. Then, the eight male contacts 120 are housed in the housing 110. A lance (not shown) is provided in each male contact 120. The lances are then locked in the housing 110. This locking allows the position and orientation of each male contact 120 to be set in the housing 110. Then, the batch rubber stopper 130 is fitted into the housing 110. Finally, the cover member 140 is attached to the housing 110.

Now, a description will be given of the female connector 200 to which the male connector 100 is connected according to an exemplary embodiment of the present invention. The left side of FIG. 2 shows the female connector 200. Wiring extending from a control section that unlocks the door is introduced into the female connector 200. The female connector 200 has an outer housing 210, an inner housing 220, a seal ring 230, a female contact 240, a secondary locking member 250, a batch rubber stopper 260, and a cover member 270.

The outer housing 210 is composed of a flexible plastic material. The outer housing 210 is provided with a lock arm 211 and paired unlocking sections 212. The lock arm 211 has a lock section 2111 at one end and a cam engaging section 2112 at the other end. A locking slot 2111a is formed in the lock section 2111. A tapered surface 112a is formed in the large locking projection 112, provided on the hood section 110a of the male connector 100 according to the present embodiment. When the male connector 100 according to the present embodiment and the mating female connector 200 are mated, the tapered surface 112a of the locking projection 112 of the male connector 100 raises the lock section 2111 of the female connector 200. Then, as the mating continues, the locking projection 112 slips into and engages with the locking slot 2111 a of the lock section 2111. To unmate the male and female connectors from each other, both may be separated from each other with the lock section 2111 raised. The cam engaging section 2112 has tapered surfaces 2112a on both sides of it. The tapered surfaces 2112a are inclined toward the bottom of FIG. 2 so as to near the respective sides of the outer housing 210.

The paired unlocking sections 212 are provided on the respective sides of the outer housing 210. The paired unlocking sections 212 project from respective sides of a mating surface of the female connector 200 in a direction opposite to the mating direction. When leading ends 212a of the paired unlocking sections 212 in a direction opposite the mating direction are pushed toward each other from the outside, the paired unlocking sections 212 are deflected using trailing ends in the direction opposite the mating direction (the right-hand ends in FIG. 2) 212b as a pivot shaft. Each of the paired unlocking sections 212 is provided with a folded piece 2121 folded toward-the cam engaging section 2112 of the lock arm 211. A leading end surface of the folded piece 2121 which is closer to the cam engaging section 2112 is almost parallel to the taper of the tapered surface 2112a of the cam engaging section 2112. When the leading ends 212a of the paired unlocking sections 212 are pushed toward each other from the outside, the folded pieces 2121 cam-engage with the respective cam engaging sections 2112 of the lock arm 211. The operating section 212 is pushed down to raise the lock section 2111. Further, each of the paired unlocking sections 212 has two projections 2122 arranged in parallel in a horizontal direction. The female connector 200, shown in FIG. 2, is attached to a door frame (not shown) by inserting the projections 2122 into the door frame. Projecting leading end surfaces 2122a of the projections 2122 are chamfered so as to be easily inserted into the door frame. To unmate the male connector 100 and the female connector 200, shown in FIG. 2 and attached to the door frame, both may be separated from each other so that the leading ends 212a of the paired unlocking sections 212, provided on the female connector 200, shown in FIG. 2, are pushed toward each other from the outside. Further, the projections 2122 inserted into the door frame slip out of it by the operation of pushing the paired unlocking sections 212 toward each other from the outside. Then, the female connector 200 can be removed from the door frame.

One conductor 320 is connected to the one female contact 240, shown in FIG. 2. As in the case of the male contact 120, FIG. 2 shows only one female contact 240 but the wiring introduced into the female connector 200, shown in FIG. 2 is composed of eight conductors 320 similarly to the wiring introduced into the male connector 100 according to the present embodiment. Actually, eight female contacts 240 are installed.

An inner housing 220 shown in FIG. 2 is composed of a plastic material to which a glass material is added. The inner housing 220 is thus inflexible and has a high dimensional precision. The inner housing 220 is provided with three main body sections: a large 223, intermediate-sized 222, and small 221 main body sections. The eight female contacts 240 are housed in the inner housing 220 so that their leading ends are located inside the small main body section 221. An outer peripheral surface of the small main body section 221 is provided with multiple locking projections 2211 locking the seal ring 230. Further, the inner housing 220 is inserted into the outer housing 210. An outer peripheral surface of the intermediate-sized main body section 222 of the inner housing 220 is provided with a locking projection 2221 that is locked in the outer housing 210. Moreover, an outer peripheral surface of the large main body section 223 of the inner housing 220 is provided with multiple locking projections 2231 over which the cover member 270 is locked.

The secondary locking member 250 holds the eight female contacts 240. The male connector 100 according to the present embodiment does not include such a secondary locking member. Once the male connector 100 according to the present embodiment is attached to the door handle 1, shown in FIG. 1, the wiring connected to the male contacts 120 is no longer pulled. In contrast, the wiring connected to the female contacts 240 may be pulled for its routing during the assembly of the door panel after the connection. Accordingly, the female contacts 240 must be held more firmly than the male contacts 120. Thus, the female connector 200 is provided with the secondary locking member 250. The secondary locking member 250, shown in FIG. 2, has four closed cavities 251 arranged in one vertical line and four open cavities 252 arranged in one vertical line in FIG. 2. Rear halves (left-hand halves in FIG. 2) of the eight female contacts 240 are housed in the cavities 251 and 252. The secondary locking member 250 is provided with a concave portion 253 into which a jig is inserted during assembly.

The batch rubber stopper 260 is provided at a port into which the female connector 200 is introduced. Accordingly, after the female connector 200 has been mounted inside the door panel, even if external water runs along the door frame (not shown) or the like and reaches the wiring introduction port of the female connector 200, the batch rubber stopper 260 hinders the water from infiltrating into the female contact 240. This reliably makes the connector waterproof. The batch rubber stopper 260 is a plate-like rubber member having a total of eight through-holes 261 arranged in two vertical lines each including four of them, as shown in FIG. 2. The eight conductors are inserted through the respective through-holes 261. The batch rubber stopper 260 has a total of 15 concave sections 262 arranged in three vertical lines each including five of them in addition to the through-holes 261.

The cover member 270 is also formed with eight through-holes 271 corresponding to the eight through-holes 261, formed in the batch rubber stopper 260. The eight conductors 320 are inserted through the respective through-holes 271. The cover member 270 is also provided with 15 convex sections 272 corresponding to the 15 concave sections 262, formed in the batch rubber stopper 260. The cover member 270 is further provided with locking levers 273 into which the respective locking projections 2231, provided on the large main body section 223 of the inner housing 200, are slipped.

Now, description will be given of a process of assembling the female connector 200, shown in FIG. 2.

First, as in the case of the process of assembling the male connector 100 according to the present embodiment, the leading ends of the eight conductors 320are passed through the respective through-holes 271 in the cover member 270 and then through the respective through-holes 261 in the batch rubber stopper 260. Next, a connecting operation is performed. In the connecting operation, the leading ends of the eight conductors 320 are crimped to the respective female contacts 240. Additionally, the following two operations are performed: the operation of fitting the secondary locking member 250 into the inner housing 220 and the operation of covering the small main body section 221 of the inner housing 220 with the seal ring 230 and then using the multiple locking projections 2211, provided on the small main body section 221, to lock the seal ring 230. Then, the female contacts 240 to which the conductors 320 are connected are inserted through the secondary locking member 250 in the inner housing 220. Each of the female contacts 240 is provided with a lance (not shown). When the female contact 240 is inserted until the leading end of the female contact 240 is positioned inside the small main body section 221 of the inner housing 220, the lances are locked in the inner housing 220 to set the position and orientation of each female contact 240 in the inner housing 220. Then, a jig is inserted into the concave portion 253, formed in the secondary locking member 250 in the inner housing 220, to slide the secondary locking member 250 in a direction toward the reader in FIG. 2. Thus, each female contact 240 is locked and held in the secondary locking member 250. Subsequently, the batch rubber stopper 260 is fitted into the large main body section 223 of the inner housing 220. Moreover, the cover member 270 is attached to the inner housing 220. In attaching the cover member 270, the multiple locking levers 273 of the cover member 270 are locked over the respective locking projections 2231, provided on the large main body section 223 of the inner housing 220. Finally, the inner housing 220 is mounted in the outer housing 210. In mounting the inner housing 220, the locking projection 2221, provided on the intermediate-sized main body section 222 of the inner housing 220, is-locked in the outer housing 210. When the thus assembled female connector 200 and the male connector 100 according to the present embodiment are mated with each other, the seal ring 230, provided in the female connector 200, reliably makes the mated surfaces of both connectors waterproof.

Next, with reference to FIG. 3, description will be given of a method of attaching the male connector 100, shown in FIG. 2, to the door handle 1.

FIG. 3 is a perspective view showing the fulcrum end of the door handle shown in FIG. 1. The male connector 100 according to the present embodiment, is inverted through 180° in the vertical direction from the orientation shown in FIG. 2. Wiring 31 extending from a sensor (not shown) built into the door handle 1 is connected to the male contacts 120, provided in the male connector 100. FIG. 3 also shows a handle guide 2.

Each side of the fulcrum end 10 of the door handle 1, shown in FIG. 3, is provided with a locking projection 11 and a small locking projection 12. Moreover, a leading end of the door handle 1 is provided with an inverse T-shaped projection 13 in its center.

To attach the male connector 100 according to the present embodiment to the end 10 of the door handle 1, the locking projection 11 of the door handle 1 slip into the respective larger locking holes 1111 in the paired latch arms 111, provided in the male connector 100. The locking pawls 143 of the cover member 140, shown in FIG. 2, have already been slipped into the respective smaller locking holes 1112 in the paired latch arms 111, provided in the male connector 100, shown in FIG. 3. A tapered surface 11a is provided on each of the locking projections 11 of the door handle 1. When the male connector 100 is attached to the end 10 of the door handle 1, the paired latch arms 111 of the male connector 100 are pushed open by the tapered surfaces 11a. Then, the locking projections 11 of the door handle 1 slip into the respective larger locking holes 1111 in the paired latch arms 111. Further, the wing section 110b of the male connector 100 according to the present embodiment is provided with a notch 114 shaped so as to conform to the inverse T-shaped projecting section 13 of the door handle 1. When the male connector 100 is attached to the end 10 of the door handle 1, the inverse T-shaped projection 13 fits into the notch 114. To remove the male connector 100 attached to the door handle 1 from the door handle 1, a jig or the like is used to push open the paired latch arms 111 to separate the male connector 100 from the door handle 1. Then, the locking projections 1 la of the door handle 1 slip out of the locking holes 1111 in the paired latch arms 111 to allow the male connector 100 to be removed from the door handle 1. Therefore, the male connector 100 of the present embodiment can be removed from the door handle 1, thus eliminating the necessity to also replace the door handle 1 when the connector is replaced.

The handle guide 2, shown in FIG. 3, is provided with locking holes 21 on respective side walls and a shock absorbing member 22 on a leading end surface standing opposite the door handle 1. After the male connector 100 has been attached to the door handle 1, the handle guide 2 placed over the male connector 100 is pushed toward the door handle 1 so as to insert the small locking projection 12 of the door handle 1 into the locking hole 21 of the handle guide 2. Then, the shock absorbing member 22 is positioned so as to cover that surface 110b′ of the wing section 110b of the male connector 100 on which the hood section 110a is provided. When the male connector 100 and the female connector 200, shown in FIG. 2, are fitted into each other, the shock absorbing member 22 collides with the door frame (not shown). However, the shock absorbing member 22 absorbs the shock of the collision.

Now, description will be given of a second embodiment of the connector according to the present invention. However, in this case, description will be given only of differences between the second embodiment and the male connector shown in FIG. 2. The same components as those of the male connector shown in FIG. 2 will be denoted by the same reference numerals as those used in the description of the male connector shown in FIG. 2.

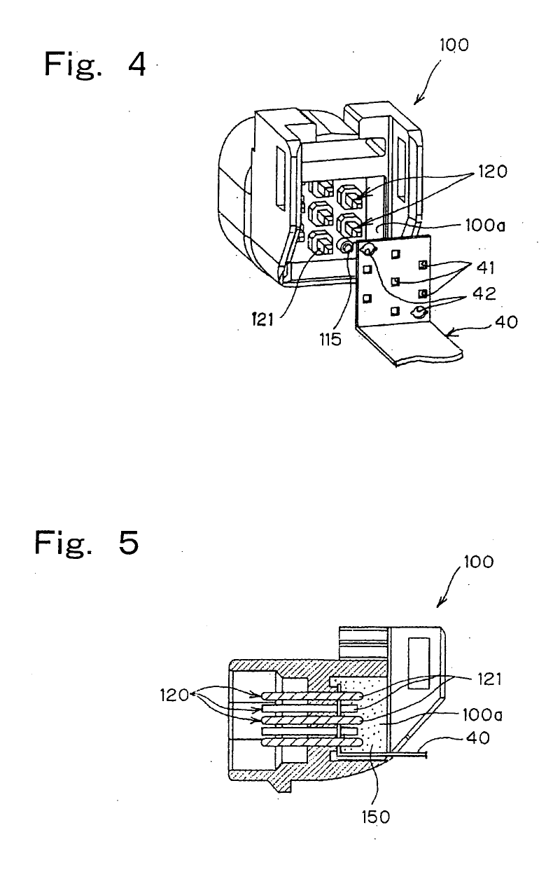

??? According to an alternative exemplary embodiment, as shown in FIG. 4, the male connector 100 is again attached to the end 11 of the door handle 1, shown in FIG. 1. A flexible printed circuit board (FPC) 40 having seven flat conductors arranged in parallel is introduced into the male connector 100. The male connector 100 shown in FIG. 4 includes a total of seven male contacts 120. A wiring introduction port 100a has connection sections 121 of the seven male contacts 120 arranged in three vertical lines in FIG. 4 and to which the respective flat conductors are connected. Moreover, the wiring introduction port 100a has FPC fixing bosses 115 provided in its upper left and right corners, respectively. Further, although, in the male connector shown in FIG. 2, the cover member 140 presses the batch rubber stopper 130, the male connector 100 shown in FIG. 4 is not provided with the batch rubber stopper 130 or cover member 140. When the male connector 100 shown in FIG. 4 is assembled, an aqueous potting agent is injected instead of fitting the batch rubber stopper 130 into the housing 110. That is, the aqueous potting agent is injected into a space in the wiring introduction port 100a to solidify the injected potting agent.

A leading end of the FPC 40 introduced into the male connector 100 shown in FIG. 4 is folded through 90°. In the folded leading end, rectangular slots 41 are formed at positions corresponding to male contacts 120 and boss holes 42 are formed at positions corresponding to FPC fixing bosses 115.

As shown in FIG. 5, the folded leading end of the FPC 40, shown in FIG. 4, is introduced into the wiring introduction port 100a of the male connector 100. Although not shown in FIG. 5, the FPC fixing bosses 115 of the male connector 100, shown in FIG. 4, slip into the respective boss holes 42, shown in FIG. 4 and formed in the FPC 40. Thus, the FPC 40 is fixed to the male connector 100. As further shown in FIG. 5, a connection section 121 of each male contact 120, provided in the male connector 100, penetrates the corresponding rectangular slot 41, shown in FIG. 4 and formed in the FPC 40. Moreover, each connection section 121 is soldered to the FPC 40. Further, a solidified potting agent 150 is provided in a space in the wiring introduction port 100a of the male connector 100, shown in FIG. 5. The solidified potting agent 150 covers the connection sections 121 of the male contacts 120 and the leading end of the FPC 40. The solidified potting agent 150 functions as a waterproof member for the connector. Thus, the male connector 100 shown in FIG. 5 reliably prevents the infiltration of water into the connector.

Now another alternative exemplary embodiment will be described. In this embodiment, the same components as those of the male connector shown in FIG. 2 will be denoted by the same reference numerals as those used in the description of the male connector shown in FIG. 2. Description will be given only of differences between the present embodiment and the male connectors shown in FIGS. 2 and 5. The connector according to the present embodiment is of a female type and has female contacts. Further, the connector according to the present embodiment is also provided with paired latch arms (not shown) in the housing similarly to the male connector 100 shown in FIG. 2 or 5. The paired latch arms can be used to removably attach the connector to the end 11 of the door handle 1, shown in FIG. 3. This eliminates the necessity to also replace the door handle 1 when the connector is replaced.

FIG. 6 is a perspective view of the female connector according to the present embodiment as viewed from the wiring introduction port.

FIG. 6 shows a part of a female connector 100′ by omitting the illustration of the paired latch arms 111 so that the wiring introduction port 100a of the female connector 100′ of the present embodiment can be easily seen. A flexible flat cable (FFC) 50 having seven flat conductors arranged in parallel is introduced into the female connector 100′, partly shown in FIG. 6. Although FIG. 6 shows only two female contacts 120′, the female connector 100′ actually includes a total of seven female contacts 120′.

A leading end of the FFC 50, shown in FIG. 6, is folded through 90°, as in the case of the FPC 40, shown in FIG. 4. In the folded leading end, connection sections (not shown) are provided at positions corresponding to the female contacts 120′.

Further, when the female connector 100′ according to the present embodiment is assembled, paired seal members 160 are installed in the housing 110 instead of fitting the batch rubber stopper 130 into the housing or injecting the potting agent into the housing. The paired seal members 160 are like jelly and have an equal size. The paired seal members 160 are installed so as to sandwich the folded leading end of the FFC 50 between them. The seal member 161 located at the leading end of the female connector 100′ in the fitting direction is formed with seven slits 1611 corresponding to the arrangement of the female contacts 120′ provided in the female connector 100′. Moreover, the housing 110 of the female connector 100′ is provided with a cover 170 that opens and closes the wiring introduction port 100a.

With the female connector 100′ according to the present embodiment, with the cover 170 open, the seal member 161 with the slits 1611 is first slipped into the wiring introduction port 100a of the female connector 100′. Then, trailing ends of the female contacts 120′ are allowed to pierce connection sections (not shown) of the FFC 50 for connections. Then, leading ends of the female contacts 120′ connected to the FFC 50 are passed through the respective slits 1611 in the seal member 161, installed in the wiring introduction port 100a. The female contacts 120′ are housed in the housing 110. Next, the other seal member 162 is placed on the folded leading end of the FFC 50. Finally, the cover 170 is closed. The other seal member 162 placed on the FFC 50 is pressed by the cover 170. The paired jelly-like seal members 160 function as waterproof members for the mated surface of the connector. Thus, the female connector 100′ shown in FIG. 6 also prevents the infiltration of water into the connector.

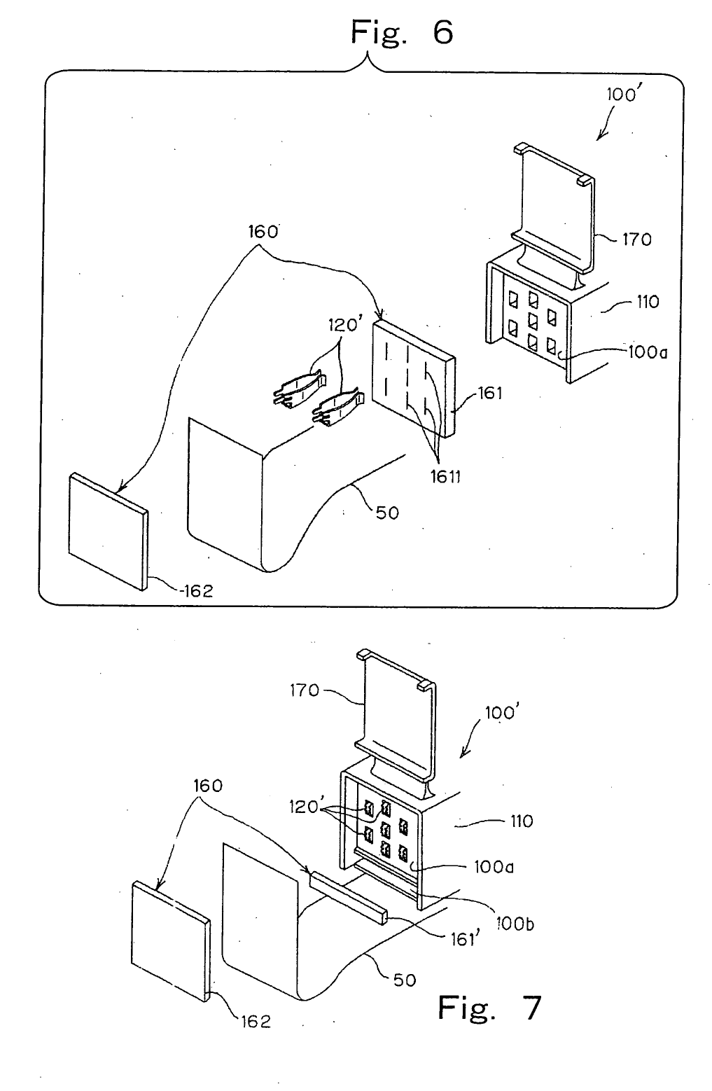

Now, an alternative form of the third embodiment will be described with reference to FIG. 7. This variation uses paired jelly-like seal members having different sizes Like FIG. 6, FIG. 7 shows a part of the female connector 100′ by omitting the illustration of the paired latch arms so that the wiring introduction port 100a of the female connector 100′ of the present embodiment can be easily seen. An FFC 50 similar to the FFC shown in FIG. 6 is introduced into the female connector 100′, partly shown in FIG. 7. FIG. 7 shows the FFC 50 running under the female connector 100′ and having its leading end folded upward.

The female contact 120′ is housed in the housing 110 of the female connector 100′ according to the present variation before the paired seal members 160 are installed in the wiring introduction port 100a. Of the paired seal members 160 shown in FIG. 7, a seal member 161′ located at the leading end of the female connector 100′ in the fitting direction is like a bar.

With the female connector 100′ according to the variation, with the cover 170 open, the bar-like seal member 161′ is installed at the bottom of the wiring introduction port 100a, that is, an inlet opening section 100b of the wiring introduction port 100a. Then, the female contacts 120′ are allowed to pierce connection sections (not shown) of the FFC 50. Subsequently, the other seal member 162 is placed on the folded leading end of the FFC 50. Finally, the cover 170 is closed. In this variation, only the inlet opening section of the wiring introduction port 100a is sealed. Since it is most likely that water infiltrates into the inlet opening section, this variation saves the material of the seal member and effectively prevents the infiltration of water into the connector.

The connector according to the present invention is applicable to both male and female connectors. The connector according to the present invention is also applicable not only to connectors attached to door handles of automobiles but also to connectors attached to various door handles.

1. A connector attached to a fulcrum end of a pivotal door handle having wiring extending from a sensor introduced therein, the sensor being built into the door handle to detect a predetermined signal from surroundings, the connector having a contact connected to the wiring, the connector comprising:
a pair of latch arms provided on respective sides of the door handle and which can be installed in and removed from the door handle; and
a seal member provided at a port through which the wiring is introduced.

2. The connector according to claim 1, wherein the contact comprises a plurality of terminals connected to respective conductors of the wiring, and
the seal member is a plate-like rubber member having a plurality of through-holes through which the respective conductors are inserted.

3. The connector according to claim 1, wherein the contact is connected to wiring in which a plurality of flat conductors are arranged in parallel, and
the seal member is obtained by solidifying an aqueous waterproof filler.

4. The connector according to claim 1, wherein the contact is connected to wiring in which a plurality of flat conductors are arranged in parallel, and
the seal member is like jelly.

5. The connector according to claim 1, wherein the connector is attached to the door handle by one or more locking projections that slip a respective larger locking hole.

6. The connector according to claim 5, wherein the locking projection is disposed on the handle and the locking hole is provided in the connector.
